(19) United States
(12) Patent Application Publication
(10) Pub. No.: US 2025/0255365 A1
(43) Pub. Date: Aug. 14, 2025

(54) Cleanroom Fabric and Garment

(71) Applicant: Burlington Industries LLC, Charlotte, NC (US)

(72) Inventors: Kiarash Arangdad, Cary, NC (US); Nathaniel Terry, Burlington, NC (US); Belinda Burt, Burlington, NC (US); Tamara Mease, Burlington, NC (US); Andrew Hicks, Burlington, NC (US)

(21) Appl. No.: 19/051,631

(22) Filed: Feb. 12, 2025

Related U.S. Application Data
(60) Provisional application No. 63/552,433, filed on Feb. 12, 2024.
(60) Provisional application No. 63/666,739, filed on Jul. 2, 2024.

(51) Int. Cl. A41D 13/02; A62B 17/00

(52) U.S. Cl. CPC A41D 13/02; A62B 17/006; A41D 2500/20; A41D 2500/50

(57) ABSTRACT

A treated fabric is disclosed that is particularly well suited for constructing cleanroom garments. The fabric and garments made according to the present disclosure have extremely low lint properties and can be constructed to have a very high hydrostatic head. The fabric treatment can comprise chemistries that are not fluorinated. The fabric treatment guarantees high performance level after undergoing multiple cycles of washing, drying, sterilization, autoclaving, and even gamma processing where untreated fabrics are more susceptible to abrasion, resulting in the release of particles. Treated fabrics demonstrate better performance in both acidic and alkaline environments, while untreated fabrics are vulnerable to these conditions, leading to a shortened lifetime. The cleanroom fabric described in this context ensures garments remain free of both human body and garment-generated dust. The airborne contamination control provided by the treated fabric is needed for pharmaceutical, medical device, semiconductor, and microelectronic manufacturing industries.

### RELATED APPLICATIONS

The present application is based upon and claims priority to U.S. Provisional Patent Application Ser. No. 63/552,433, filed on Feb. 12, 2024, and to U.S. Provisional Patent Application Ser. No. 63/666,739, filed on Jul. 2, 2024, which are incorporated herein by reference in its entirety.

### BACKGROUND

Cleanroom garments are intended to be worn in cleanrooms where a contamination control program is in place. Various different activities can occur in a cleanroom. For instance, cleanrooms are used to construct electronic devices, including integrated circuit chips, and the like. Cleanrooms are also used in the pharmaceutical industry to produce pharmaceuticals and biologics. In cleanroom environments, one of the primary sources of contamination comes from the people entering and leaving the cleanroom. Consequently, having workers wear specially designed cleanroom garments can be essential for minimizing contamination within the cleanroom.

Cleanroom garments should provide the wearer with static/anti-static control from electrostatic discharge and should be comfortable to wear. Cleanroom garments should also be designed to inhibit or prevent the release of particles from the garment while being worn. In this regard, the Institute of Environmental Sciences and Technologies provides specification for garments entering a cleanroom. These specifications can be found in IEST-RP-CC003.5, which is incorporated herein by reference. According to IEST, garments and fabrics should exhibit a specific degree of contamination control based upon the environment in which they are used. According to IEST, for instance, garments can be categorized according to Category I, Category II, or Category III based upon the particle emission rates of the garments. Category I garments, for instance, have a much lower particle emission rate than Category III garments.

Cleanroom garments produced in the past, for instance, are disclosed in U.S. Pat. No. 6,675,838, U.S. Patent Application Publication No. 2006/0272070, and U.S. Patent Application Publication No. 2015/0203995, which are all incorporated herein by reference.

In the past, efforts have been made to produce cleanroom garments from fabrics containing polyester and/or polyolefin polymers. These garments, however, have a tendency to have a relatively high particle emission rate. Thus, the fabrics have been treated in the past in order to inhibit particle release. For example, the fabrics have been treated with fluoropolymer-based treatments, such as treatments containing polytetrafluoroethylene. Although the fluoropolymer treatment has reduced particle emission rates, recent government regulations and controls have been enacted that have limited the use of fluorine-based polymers in various garments.

In view of the above, a need currently exists for an improved fabric material and cleanroom garments made from the fabric material that exhibit a very low particle emission rate. A need also exists for a fabric material and garments made from the fabric material that are treated with a particle capturing treatment that does not contain fluoropolymers including fluorinated carboxylic acid derivatives of hexanoic acid (PFHxA), Perfluorooctanoic acid (PFOA), Perfluorooctanesulfonic acid (PFOS) and polytetrafluoroethylene (PTFE).

### SUMMARY

In general, the present disclosure is directed to a fabric material and to cleanroom garments made from the fabric material. As will be explained in greater detail below, the fabric material is treated with a particle resistant agent that is non-fluorinated. The resulting fabric material demonstrates superior and unexpectedly better particle emission rates in comparison to many conventional fabrics.

In one aspect, the present disclosure is directed to a cleanroom garment comprising a fabric material. The fabric material can be a woven fabric or nonwoven fabric and can comprise filament yarns comprising a polymer. The polymer, for instance, can comprise a polyester polymer or an inherently flame resistant polymer and the yarns can comprise multifilament yarns. The fabric can be constructed so as not to contain any spun yarns. The fabric material can contain an anti-static agent. The anti-static agent, for instance, can comprise a conductive yarn, such as yarns containing carbon or can comprise non-fibrous carbon. Carbon can be present in the fabric material in an amount from about 0.5% by weight to about 5% by weight. In one aspect, the carbon can be in the form of fibers and can comprise bicomponent fibers.

As described above, the woven fabric can be made from multifilament yarns containing an inherently flame resistant polymer. The yarns can be continuous multifilament yarns or can comprise stretched-broken multifilament yarns. The inherently flame resistant polymer, for instance, can comprise a para-aramid polymer, a meta-aramid polymer, or a combination thereof. In one embodiment, the woven fabric is made from inherently flame resistant yarns such that the fabric is comprised of greater than about 80% by weight, such as greater than about 85% by weight, such as greater than about 90% by weight, such as greater than about 95% by weight of one or more inherently flame resistant polymers. The one or more inherently flame resistant polymers can comprise less than about 99.5% by weight of the woven fabric, such as less than about 99% by weight of the fabric. For instance, the remainder of the fabric may comprise the anti-static agent.

When the fabric is made from polyester yarns, in one embodiment, the polyester yarns or the fabric can be pre-treated in order to remove cyclic and linear oligomers from the polyester polymer. For instance, the polyester yarns can be treated with soda ash and combined with detergent at high temperature.

In one embodiment, the fabric material can comprise the woven fabric laminated to a membrane, such as a polymer membrane. The polymer membrane can serve to further decrease particle emissions from the fabric material.

A particle capturing treatment can be applied to the fabric materials including woven, non-woven and laminated fabrics. The particle capturing treatment can contain a particle resistant agent. The particle resistant agent can comprise a non-fluorinated polymer. The non-fluorinated polymer, for instance, can comprise a polyurethane polymer, a silicone polymer, an acrylic polymer, a polyethylene polymer, or mixtures thereof. In one aspect, the particle capturing treatment can be fluorine-free. For instance, the particle capturing treatment can be formulated so as not to contain any fluoropolymers including fluorinated carboxylic acid derivatives of hexanoic acid (PFHxA), Perfluorooctanoic acid (PFOA), Perfluorooctanesulfonic acid (PFOS) and/polytetrafluoroethylene (PTFE).

In one aspect, the particle capturing treatment can comprise at least one polyurethane polymer and at least one acrylic polymer, can comprise at least one polyurethane polymer and at least one such as at least two polyethylene polymers, or can comprise at least one polyethylene polymer and at least one acrylic polymer. In one aspect, the particle resistant agent can comprise a bio-based polymer, such as a bio-based polyurethane or a bio-based acrylic polymer. For example, the particle resistant agent can have a mean bio-based carbon content of at least about 25%, such as at least about 35%, such as at least about 40%, such as at least about 45%, such as at least about 50%, such as at least about 55%, such as at least about 60%, such as at least about 65%, such as at least about 70% (by weight).

The cleanroom garment can comprise a head covering, a frock, coveralls (which can be one piece or two pieces) or a foot covering.

In accordance with the present disclosure, when tested according to the Helmke Drum Test, the treated fabric material displays a particle emission rate of less than 500 particles having a particle size of 0.5 microns or greater after 25 laundry cycles. For example, after 25 laundry cycles, the treated fabric material can display a particle emission rate of less than about 300 particles, such as less than about 200 particles, such as less than about 100 particles, such as less than about 80 particles having a particle size of 0.5 microns or greater. Similarly, after 50 laundry cycles, the fabric material can also display a particle emission rate of less than about 300 particles, such as less than about 200 particles, such as less than about 100 particles, such as less than about 80 particles having a particle size of 0.5 microns or greater.

Even after 100 laundry cycles, the treated fabric material of the present disclosure can display a particle emission rate of less than about 500 particles having a particle size of 0.5 microns or greater. For instance, the treated fabric material can display a particle emission rate of less than about 400 particles, such as less than about 300 particles, such as less than about 200 particles having a particle size of 0.5 microns or greater.

When tested according to the Helmke Drum Test, the cleanroom garment can display a particle emission rate of less than about 12,000 particles, such as less than about 10,000 particles, such as less than about 8,000 particles, such as less than about 6,000 particles, such as even less than about 4,000 particles per minute when measuring particles having a size of 0.5 microns and greater.

The fabric material of the present disclosure also displays excellent hydrostatic head properties. For instance, when tested according to Test AATC-127-2018, the treated fabric material can display a hydrostatic head after 25 laundry cycles or after 50 laundry cycles of greater than about 500 mm water, such as greater than about 700 mm water, such as greater than about 800 mm water, such as greater than about 900 mm water, such as even greater than about 1,000 mm water.

In one aspect, the fabric material can also be treated with an antimicrobial agent. The antimicrobial agent, for instance, can comprise a quaternary ammonium compound, such as a silane quaternary ammonium halide. In one aspect, the antimicrobial agent comprises 3-(trimethoxysilyl) propyldimethyloctadecyl ammonium chloride. Alternatively, the antimicrobial agent can comprise silver, a silver compound, zinc, a zinc compound, plant derived antimicrobial agents, peppermint, and the like.

In one aspect, the particle capturing treatment applied to the woven fabric can be completely fluoropolymer-free. In one aspect, the particle capturing treatment can contain a wax, such as a paraffin wax. The particle capturing treatment can also contain a latent crosslinking agent, such as a blocked isocyanate.

The woven fabric can generally have a basis weight of greater than about 1 osy, such as greater than about 2 osy, such as greater than about 2.2 osy, such as greater than about 2.4 osy, and less than about 8 osy, such as less than about 7 osy, such as less than about 6 osy, such as less than about 5 osy, such as less than about 4 osy such as less than about 3.5 osy. In one aspect, the fabric material is made from multifilament polyester yarns. The yarns can be flattened by subjecting the treated fabric material to a calendering process. The woven fabric can have a yarn density in a warp direction of from about 100 yarns per inch to about 200 yarns per inch, such as from about 125 yarns per inch to about 200 yarns per inch, and in the fill direction of from about 70 yarns per inch to about 120 yarns per inch. In one aspect, the woven fabric can have a plain weave. In one embodiment, the anti-static agent can comprise conductive yarns, such as yarns containing carbon. In one aspect, the anti-static yarns or fibers can be present in the woven fabric in a grid-like pattern extending in the warp direction and the weft direction. For instance, in the warp direction, one anti-static yarn can be present in between from about 25 to about 40 polymer yarns. The anti-static yarns can be present in the weft direction at a ratio of about 1 anti-static yarn positioned between from about 15 to about 25 polymer yarns. In one aspect, the presence of the anti-static yarns produces a striped pattern on the fabric.

The treated fabric material of the present disclosure may also have various other beneficial properties and characteristics. For instance, the treated fabric material can display a static decay of less than about 2 seconds, such as less than about 1.75 seconds, such as less than about 1.5 seconds when measured according to FTM4046. The treated fabric material can also display a surface resistivity of from about 1×10⁵ ohms/square to about 1×10¹² ohms/square when measured according to Test AATCC-76.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a cleanroom garment made in accordance with the present disclosure;

FIG. 2 is a perspective view of one embodiment of a cleanroom garment made in accordance with the present disclosure;

FIG. 3 is a perspective view of one embodiment of a cleanroom garment made in accordance with the present disclosure;

FIG. 4 is a perspective view of one embodiment of a cleanroom garment made in accordance with the present disclosure;

FIG. 5 is a perspective view of one embodiment of a cleanroom garment made in accordance with the present disclosure.

Repeat use of reference characters in the present specification and drawings is intended to represent the same or analogous features or elements of the present invention.

### Definitions and Standardized Procedures

The following definitions and procedures are offered in order to better describe and quantify the performance of protective garments and fabrics made according to the present disclosure.

As used herein, the Helmke Drum Test is conducted in accordance with IEST-RP-CC003.5 (2023). The Helmke Drum Test is used to quantify particles dislodged from fabrics and garments through the application of mechanical energy under dry conditions as a means of simulating particle shedding from the surface of the garment or fabric during use. Garments under test are tumbled in a rotating drum to release particles from the fabric in a controlled manner. An automatic, discrete-particle counter is used to sample the air within the drum to determine the average particle concentration of the air during the initial 10 minutes of the test.

Garments for cleanroom environments can be classified according to Category I, Category II, or Category III according to the following table:

| | Garment | Particle emission rate, G particles/min | |
|---|---|---|---|
| Category | type | 0.3 μm and larger | 0.5 μm and larger |
| I | 1 Frock | Less than 1,700 | Less than 1,000 |
| I | 1 Coverall | Less than 2,000 | Less than 1,200 |
| I | 3 Hoods | Less than 780 | Less than 450 |
| II | 1 Frock | 1,700 to 17,000 | 1,000 to 10,000 |
| II | 1 Coverall | 2,000 to 20,000 | 1,200 to 12,000 |
| II | 3 Hoods | 780 to 7,800 | 450 to 4,500 |
| III | 1 Frock | 17,000 to 170,000 | 10,000 to 100,000 |
| III | 1 Coverall | 20,000 to 200,000 | 12,000 to 120,000 |
| III | 3 Hoods | 7,800 to 78,000 | 4,500 to 45,000 |

NOTE: The particle emission rates shown for each of the garment
types are proportional to the respective areas of fabric
involved. The areas of the garments considered in the
preparation of this table are as follows:

| Garment | Average area, m² | Average area, ft² |
|---|---|---|
| type | (both sides) | (both sides) |
| Frock* | 4.63 | 49.8 |
| Coverall* | 5.99 | 64.4 |
| Hood* | 1.03 | 11.0 |

*Medium size garments

When conducting the Helmke Drum Test on a fabric sample, three equal sized pieces of fabric are tested. The total area of the three pieces of fabric is 5.99 m2 (3 panels are cut equaling the area of a medium coverall). When conducting the test on a fabric sample, the test can determine the number of particles having a particle size of 0.5 microns or greater that are shed from the fabric. For instance, low linting fabrics typically produce less than 500 particles having a particle size of 0.5 microns or greater during the test.

As used herein, the hydrostatic test is conducted according to AATC Test 127-1998.

As used herein, the test method for determining mass per unit area of a fabric is ASTM Test D3776.

Tests for cleanrooms include Test ISO 14644-1 which determines the classification of air cleanliness and ISO 14644-2 which are the specifications for testing and monitoring to prove continued compliance with ISO Test 14644-1.

As used herein, the surface resistivity can be measured according to AATCC Test 76 using a concentric electrode electrical resistance meter and preconditioning the samples at 50° relative humidity and a temperature of 23° C.±2° C. for approximately 24 hours. 100 volts are supplied during the test.

As used herein, the static charge decay test can be conducted according to Federal Test Standard 191A, Method 5931. The test fabric is supported between two electrodes that are exposed to a 5 kV source. The test conditions are 21° C. and 20% relative humidity.

As used herein, a laundry cycle may be conducted in accordance with AATCC 96-2001.

In one embodiment, a laundry cycle is conducted as follows. Laundering is preferably performed in an automatic washer, followed by drying in an automatic dryer. The following laundering test is used to determine the fabric's ability to withstand laundering.
1. 8″×10″ test specimens are combined with load fabrics (hemmed pieces of cotton sheeting or 50:50 fabric sheets having a size of 36″×36″) to give a total dry load of 4 pounds.
2. The dials on the washer are set as follows:

| | |
|---|---|
| Water Level | High |
| Wash | Cycle Normal, 12 minutes |
| Temperature | Warm Wash, 105° F.; Cold Rinse |

The test pieces and dummy load are placed in the washer and the machine is started. One ounce of TIDE (Proctor & Gamble) detergent is added while the washer is filling with soft water. If the water hardness is greater than 5 ppm, CALGON water softener (Nalco) in the amount specified by the manufacturer is added to soften the water.
3. After the washing is complete, the wet fabric including the dummy load is placed in the automatic dryer. The dryer temperature dial is set to the proper point under high heat to give a maximum vent temperature of from about 155° F. to about 160° F. The time dial is set for “Normal Cycle” for 45 minutes. The machine is started and drying is allowed to continue until the cycle is complete. The above represents one laundry cycle.
4. The fabrics are then rewashed and redried until the desired number of cycles have been completed.

Mean bio-based content can be determined according to ASTM Test D6866: 2020-02.

Using a method that relies on determining the amount of radiocarbon dating isotope 14C (half life of 5730 years) in the compositions described herein can identify whether the carbon in these compositions derives from a biosource—from modern plant or animals—or from a fossil source, or a mixture of these. Carbon from fossil sources generally has a 14C amount very close to zero. Measuring the 14C isotope amount of the polyoxymethylene [POM] polymer itself, a POM intermediate, or an article containing the POM polymer can verify that the material or article derives from a biosource of carbon and quantify the percent of biosourced carbon.

ASTM D6866 Methods A-C can be used to determine the mean biobased content by 14C isotope determination, similar to radiocarbon dating. Determining the 14C amount via these methods gives a measure of the Mean Biobased Content of the tested material, i.e., the amount of biobased carbon of the tested material as a percent of the weight (mass) of its total organic carbon. Method B may be used in one embodiment.

The result of the ASTM D6866 method can also be reported as percent Modern Carbon [“pMC”]. pMC is the ratio of the amount of radiocarbon (14C) of the testedmaterial relative to the amount of radiocarbon (14C) of the reference standard for radiocarbon dating, which is the National Institute of Standards and Technology-USA (NIST-USA) standard of a known radiocarbon content equivalent to that of the year 1950 CE. 1950 CE was chosen in part because it represents the period before the regular testing of thermonuclear weapons, which resulted in a large increase of excess radiocarbon in the atmosphere. For those using radiocarbon dates, 1950 CE equals “zero years old”. It also represents 100 pMC.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to extremely low linting fabrics. The fabrics are particularly well suited for constructing cleanroom garments. The cleanroom garments, for instance, can comprise one-piece or two-piece coveralls, frocks, head coverings including caps and hoods, shoe or foot covers, and the like.

The fabric can be constructed from filament yarns wherein each filament is made from a polymer. The polymer, for instance, can comprise a thermoplastic polymer, such as a polyester or nylon polymer. Alternatively, the polymer can comprise an inherently flame resistant polymer, such as an aramid or a modacrylic. The fabric can also contain an anti-static agent which, in one embodiment, can comprise anti-static yarns, such as conductive yarns. In accordance with the present disclosure, the fabric is treated with a particle capturing treatment. In one aspect, the particle capturing treatment is fluorine-free and can contain no fluoropolymers, such as polytetrafluoroethylene polymers. It was unexpectedly discovered that fabrics made according to the present disclosure can actually perform better than conventional fabrics treated with fluorine chemistry.

For example, treated fabrics made in accordance with the present disclosure can display a particle emission rate of less than 500 particles having a size of 0.5 microns or greater when tested according to the Helmke Drum Test. For instance, the fabric can display a particle emission rate of less than about 400 particles having a size of 0.5 microns or greater, such as less than about 300 particles having a size of 0.5 microns or greater, such as less than about 200 particles having a size of 0.5 microns or greater, such as less than about 100 particles having a size of 0.5 microns or greater when tested according to the Helmke Drum Test.

Also unexpected is that the fabric can continue to display extremely low particle emission rates even after multiple laundry cycles. Thus, the lint properties of the fabric are extremely durable, which can be relatively important when the fabric is used in a cleanroom environment. For instance, after 25 laundry cycles, the fabric can display a particle emission rate of less than about 500 particles, such as less than about 400 particles, such as less than about 300 particles, such as less than about 200 particles, such as less than about 100 particles, such as less than about 80 particles having a particle size of 0.5 microns or greater when tested according to the Helmke Drum Test. After 50 laundry cycles, the fabric of the present disclosure can display a particle emission rate of less than 500 particles, such as less than 400 particles, such as less than 300 particles, such as less than 200 particles, such as less than 100 particles, such as even less than 80 particles having a particle size of 0.5 microns or greater when tested according to the Helmke Drum Test. In fact, even after 100 laundry cycles, the fabric of the present disclosure can still display a particle emission rate of less than 500 particles, such as less than 400 particles, such as less than 300 particles, such as less than 200 particles having a particle size of 0.5 microns or greater when tested according to the Helmke Drum Test.

In one aspect, an antimicrobial agent can be incorporated into the fabric. The antimicrobial agent, for instance, can provide protection to the user against harmful microorganisms. It was discovered that adding an antimicrobial agent into the fabric can also further improve the lint properties of the fabric as will be described in greater detail below.

In addition to low lint properties, the fabric of the present disclosure can also display a relatively high hydrostatic head. For instance, when tested according to AATC-127, the fabric can display a hydrostatic head of greater than about 700 mm, such as greater than about 800 mm, such as greater than about 900 mm, such as greater than about 1,000 mm. The above hydrostatic head properties are also durable. For instance, even after 25 laundry cycles, the fabric can display a hydrostatic head of greater than about 700 mm, such as greater than about 800 mm, such as greater than about 900 mm, such as greater than about 1,000 mm, and generally less than about 5,000 mm. In fact, even after 50 laundry cycles, the treated fabric of the present disclosure can display a hydrostatic head of greater than about 600 mm, such as greater than about 700 mm, such as greater than about 800 mm, such as greater than about 900 mm, such as even greater than about 1,000 mm.

In addition to low lint properties and high hydrostatic head properties, the fabric of the present disclosure can also be constructed to have anti-static control. The fabric, for instance, can incorporate an anti-static agent that prevents or inhibits electrostatic discharge, which can be also important in cleanroom environments that are used to construct electronic devices.

In one aspect, the fabric of the present disclosure comprises a woven fabric, a non-woven fabric, or a knitted fabric and particularly a woven fabric. The fabric is formed from filament fibers, such as multifilament yarns. For example, in one aspect, the fabric can be free of spun yarns. The filament yarns can contain continuous filaments or near continuous filaments. For instance, as used herein, filament yarns can include stretch broken yarns. The filament yarns can be made from one or more polymers. In one aspect, for instance, the filaments are formed from a polyester polymer, such as polyethylene terephthalate. Alternatively, the filament fibers can be formed from a polyamide fiber or can comprise a mixture of filaments formed from a polyamide fiber and filaments formed from a polyester fiber.

In one aspect, the filaments of the multi-filament yarns are formed from an inherently flame resistant polymer. The inherently flame resistant polymer, for instance, can comprise an aramid polymer, a modacrylic polymer, or combinations thereof. Forming the fabric from inherently flame resistant yarns can protect a cleanroom operator from exposure to electric arcs or flash fires. The inherently flame resistant yarns can be combined with anti-static yarns, such as yarns containing carbon. In addition, the seams of the garment can also be constructed using a thread made from an inherently flame resistant polymer.

Although monofilament yarns may be used, the yarns, in one embodiment, comprise multifilament yarns. Each yarn, for instance, can contain greater than about 10 filaments, such as greater than about 20 filaments, such as greater than about 30 filaments, such as greater than about 40 filaments, and less than about 100 filaments, such as less than about 70 filaments, such as less than about 60 filaments.

The size of the filament yarns used to form the fabric can vary depending upon the particular application and the desired result. For instance, the size of the yarns can vary depending upon the type of garment being formed. In one aspect, the filament yarns used to form the fabric have a denier of greater than about 10, such as greater than about 25, such as greater than about 50, such as greater than about 75, such as greater than about 100, such as greater than about 125, such as greater than about 150, such as greater than about 175. The denier of the yarns can be less than about 800, such as less than about 700, such as less than about 600, such as less than about 500, such as less than about 400, such as less than about 350, such as less than about 300, such as less than about 275, such as less than about 200, such as less than about 150, such as less than about 100. As described above, the fabric can generally be free of spun yarns or can contain spun yarns in less than about 2% by weight.

Each yarn can include a single end or can include two ends. Optionally, the yarns can be textured. In such yarns, the filaments are distorted from their generally rectilinear condition to increase the bulk of the yarn and also to provide an ability for a fabric woven therefrom to stretch. A textured yarn may be “set” by heat relaxation to minimize its stretch characteristic, while maintaining its increased bulk, i.e., higher bulked denier.

There are several types of textured yarns capable of being produced by various methods. Different types of textured yarns have different characteristics, some being more expensive than others. The textured yarns that may be employed in the present fabric constructions, or referenced herein, are:
(1) False twist yarn is twisted in one direction, set, then twisted in the opposite direction and set. The twisting, setting, opposite twisting are repeated throughout the length of the yarn.
(2) Core and effect yarn (also known as “core bulked” yarns) is a multiple ended yarn, usually comprising two ends in which one end is essentially straight. The filaments of other end are distorted around the core end and sometimes through the core end.
(3) Air texturized core and effect yarn—is a core and effect yarn in which distortion of the filaments is done by air jet means. An air texturized core and effect yarn has unique properties which distinguish it from other textured yarns. These unique properties have been found effective in attaining the ends herein sought.

In one aspect, the fabric of the present disclosure is a woven fabric including a warp direction made of warp yarns and a fill direction made of fill yarns. The warp yarns and the fill yarns can be made from exactly the same yarns or can be made from different yarns. In still another embodiment, the warp yarns can be made from two or more different types of yarns while the fill yarns can also be made from the same or two or more different types of yarns. The yarns can vary in filaments per yarn, the polymer used to produce the yarns, and/or the size of the yarns. In one embodiment, the warp yarns and the fill yarns are both made from multifilament polyester yarns having the same size in combination with an anti-static yarn that extends in either the warp direction, the fill direction, or in both directions.

The anti-static yarns can provide the resulting fabric with anti-static control. The anti-static yarns, for instance, may comprise conductive yarns. In one aspect, the anti-static yarns contain carbon, such as carbon fibers. The carbon fibers, for instance, can comprise a filament fiber.

In one embodiment, the anti-static agent or yarns can comprise a bicomponent yarn containing a core fiber comprising carbon surrounded by a sheath comprising a polymer. For instance, the core/sheath bicomponent fiber may be comprised of a polyester or polyamide sheath surrounding a carbon core. Alternatively, the polyester or polyamide may comprise the core while the carbon may provide the sheath component.

The bicomponent fibers may be produced by utilizing an extrusion process such as a co-extrusion process. For instance, the core component may be extruded contemporaneously as the sheath component is extruded to surround the core component. Alternatively, the sheath component may be extruded onto the core component after the core component has been extruded. In one embodiment, the bicomponent fibers may be concentric core/sheath bicomponent fibers. In an alternative embodiment, the bicomponent fibers may be eccentric core/sheath bicomponent fibers. The bicomponent fibers utilized may be those that are commercially available and produced using any method known in the art.

However, it should be understood that the present disclosure is not limited to bicomponent fibers and that any filament fiber known in the art may be employed. For instance, any carbon fiber or poly/carbon fiber known in the art may be employed within the fabric.

The anti-static yarns can have a size that is similar to the size of the multifilament yarns used to produce the matrix of the fabric. For instance, the anti-static yarns can have a size of greater than about 20 denier, such as greater than about 30 denier, such as greater than about 40 denier, such as greater than about 50 denier, and generally less than about 200 denier, such as less than about 100 denier, such as less than about 80 denier, such as less than about 70 denier, such as less than about 60 denier.

In one application, the anti-static yarns can be present in the fabric such that the fabric contains less than about 10% by weight carbon, such as less than about 5% by weight carbon, such as less than about 4% by weight carbon, such as less than about 3% by weight carbon, such as less than about 2.5% by weight carbon and greater than about 0.3% by weight carbon, such as greater than about 0.5% by weight carbon, such as greater than about 0.8% by weight carbon.

In general, various different weave patterns may be used to produce the fabric. The fabric weave, for instance, can contribute in lowering particle emissions. For instance, a tighter weave can entrap particles, preventing the passage of particles from one side to the other side of the fabric. For instance, a twill weave, a plain weave, a ripstop weave, a herringbone weave, an oxford weave, a basket weave, or any other suitable weave may be used. In one particular embodiment, the fabric may have a ripstop weave. In another particular embodiment, the fabric may have a twill weave.

In one aspect, the fabric has a plain weave. The plain weave can include a striped pattern due to the presence of anti-static yarns. The design can include a 3 mm to 7 mm carbon grid, tightly woven with a ratio of one carbon content yarn for every 15 to 25 polymer yarns in the fill or weft direction and one carbon yarn for every 25 to 40 polymer yarns in the warp direction. This pattern aims to achieve significant reduced surface resistivity and enhanced particulate retention across 100 cleanroom cycles.

The weave density of the fabric can generally vary with the yarn sizes. The fabric of the present disclosure may have a weave density in the warp direction of greater than about 100 ends per inch, such as greater than about 120 ends per inch, such as greater than about 130 ends per inch, such as greater than about 140 ends per inch, such as greater than about 150 ends per inch and less than about 200 ends per inch, such as less than about 190 ends per inch, such as less than about 180 ends per inch, such as less than about 175 ends per inch.

The fabric of the present disclosure may have a weave density in the fill or weft direction of greater than about 70 picks per inch, such as greater than about 75 picks per inch, such as greater than about 80 picks per inch, such as greater than about 85 picks per inch and less than about 120 picks per inch, such as less than about 110 picks per inch, such as less than about 100 picks per inch.

As described above, the multi-filament yarns of the present disclosure can be made from any suitable polymer. In one aspect, the yarns can contain filaments made from polyester, from a polyamide, or from a mixture of both. In one embodiment, polyester multi-filament yarns are used containing 100% by weight of a polyester polymer. When producing the fabric from polyester yarns, the polyester yarn or the fabric material can be treated in order to remove cyclic and linear oligomers that may be present on the polyester polymer. For instance, the yarns or fabric material can be treated with soda ash and combined with a detergent at high temperature. A dispersant active substance can be used to prevent redeposition and aggregation of oligomers. Thermal treatment, for instance, can enhance the migration of oligomers to the surface. These oligomers have low solubility in water and can be crystallized and accumulated on the fiber surfaces. Such deposits can generate dust in cleanroom environments. Thus, treating the yarns or fabric in order to eliminate or reduce the amount of cyclic or linear oligomers on the polyester polymer can result in fabric having even lower emissions. In one aspect, dispersant agents such as alpha-olefin sulfonate can be employed as detergents.

In an alternative embodiment, the multi-filament yarns can be made from one or more inherently flame resistant polymers. For instance, in one aspect, the multi-filament yarns are made from inherently flame resistant polymers in an amount of 100% by weight. The filaments of the yarn, for instance, can be made from an aramid polymer, such as a para-aramid polymer and/or a meta-aramid polymer. In one aspect, for instance, the multi-filament yarns are made only from para-aramid filaments or only from meta-aramid filaments. In another aspect, the filaments of the yarn can be made from a modacrylic polymer. In this embodiment, the fabric material can contain one or more inherently flame resistant polymers in an amount greater than about 80% by weight, such as in an amount greater than about 85% by weight, such as in an amount greater than about 90% by weight, such as in an amount greater than about 95% by weight, such as in an amount greater than about 97% by weight, such as in an amount greater than about 98% by weight, such as in an amount greater than about 99% by weight.

The fabric of the present disclosure may be dyed or printed with any suitable color. Fabrics made according to the present disclosure may be dyed and/or printed prior to or after being formed into a garment.

The basis weight of fabrics made according to the present disclosure may vary depending upon various factors and the end use application. Of particular advantage, fabrics made according to the present disclosure can have excellent properties at relatively lighter basis weights. In general, the fabric may have a basis weight of at least about 1 osy, such as at least about 2 osy, such as at least about 2.2 osy, such as at least about 2.4 osy and generally less than about 10 osy, such as less than about 8 osy, such as less than about 6 osy, such as less than about 5 osy, such as less than about 4 osy, such as less than about 3.5 osy, such as less than about 3.2 osy.

In one aspect, the fabric material can include a fabric laminated to a polymer membrane. The polymer membrane, for instance, can further serve to reduce particle emissions. Although the polymer membrane can be made from a polytetrafluoroethylene polymer, in one embodiment, the membrane can be fluorine-free. For instance, the membrane can be made from a polyurethane polymer or any other suitable thermoplastic polymer. In one aspect, the membrane can be impermeable to liquid water but permeable to water vapor.

As described above, the fabric includes a particle capturing treatment that contributes to the low lint properties of the fabric. The particle capturing treatment contains a particle resistant agent optionally in combination with various other components. The particle resistant agent can comprise a polymer or other material that binds to the yarns without forming a continuous coating. In particular, the particle resistant agent can form a surface coating on the yarns while still allowing the fabric to breathe and allow for gas transmission. In this regard, the particle capturing treatment is applied to the fabric generally as a liquid and then dried and cured as opposed to a continuous coating that is laminated to the fabric or co-extruded onto the fabric.

Of particular advantage, the particle capturing treatment of the present disclosure can be formulated so as to be fluorine-free. For instance, the particle capturing treatment can be comprised of components (except for the solvent) that do not contain any fluorocarbons or be substantially free of fluorocarbons.

Substantially free, as used herein, indicates that the fabric or treatment contains fluorocarbon chemicals in an amount less than about 2% by weight, such as in an amount less than about 1% by weight, such as in an amount less than about 0.5% by weight, such as in an amount less than about 0.25% by weight, such as in an amount less than about 0.1% by weight. For example, the fabric can contain fluorine or fluorocarbon chemicals in an amount less than about 1,000 ppm, such as in an amount less than about 750 ppm, such as in an amount less than about 500 ppm, such as in an amount less than about 250 ppm, such as in an amount less than about 100 ppm, such as in an amount less than about 50 ppm, such as in an amount less than about 20 ppm, such as in an amount less than about 1,000 ppb, such as in an amount less than about 500 ppb. In one aspect, the fabric can be completely fluorine or fluorocarbon-free. Alternatively, the fabric can contain fluorine or fluorocarbon chemicals in an amount greater than about 20 ppb, such as in an amount greater than about 50 ppb, such as in an amount greater than about 100 ppb, such as in an amount greater than about 200 ppb, such as in an amount greater than about 500 ppb, such as in an amount greater than about 700 ppb, such as in an amount greater than about 1,000 ppb, such as in an amount greater than about 10,000 ppb.

In one embodiment, the particle capturing treatment is free or is substantially free of perfluorinated carboxylic acids, such as free or substantially free of perfluorooctanoic acid. For example, perfluorooctanoic acid or any perfluorinated carboxylic acids may be present in the particle capturing treatment and/or in a treated fabric in an amount less than about 2% by weight, such as in an amount less than about 1% by weight, such as in an amount of less than 0.5% by weight, such as in an amount less than about 0.25% by weight, such as in an amount less than about 0.1% by weight. For example, the particle capturing treatment can contain fluorine or fluorocarbon chemicals in an amount less than about 1,000 ppm, such as in an amount less than about 750 ppm, such as in an amount less than about 500 ppm, such as in an amount less than about 250 ppm, such as in an amount less than about 100 ppm, such as in an amount less than about 50 ppm, such as in an amount less than about 20 ppm, such as in an amount less than about 1,000 ppb, such as in an amount less than about 500 ppb. In one aspect, the particle capturing treatment can be completely fluorine or fluorocarbon-free. Alternatively, the particle capturing treatment can contain fluorine or fluorocarbon chemicals in an amount greater than about 20 ppb, such as in an amount greater than about 50 ppb, such as in an amount greater than about 100 ppb, such as in an amount greater than about 200 ppb, such as in an amount greater than about 500 ppb, such as in an amount greater than about 700 ppb, such as in an mount greater than about 1,000 ppb, such as in an amount greater than about 10,000 ppb.

In another embodiment, the particle capturing treatment can be free or substantially free of polyfluoroalkyl compounds, including C6 compounds. For instance, the particle capturing treatment and/or the treated fabric can contain one or more polyfluoroalkyl compounds in an amount less than about 2% by weight, such as in an amount less than about 1% by weight, such as in an amount less than about 0.5% by weight, such as in an amount less than about 0.25% by weight, such as in an amount less than about 0.1% by weight. For example, the particle capturing treatment can contain fluorine or fluorocarbon chemicals in an amount less than about 1,000 ppm, such as in an amount less than about 750 ppm, such as in an amount less than about 500 ppm, such as in an amount less than about 250 ppm, such as in an amount less than about 100 ppm, such as in an amount less than about 50 ppm, such as in an amount less than about 20 ppm, such as in an amount less than about 1,000 ppb, such as in an amount less than about 500 ppb. In one aspect, the particle capturing treatment can be completely fluorine or fluorocarbon-free. Alternatively, the particle capturing treatment can contain fluorine or fluorocarbon chemicals in an amount greater than about 20 ppb, such as in an amount greater than about 50 ppb, such as in an amount greater than about 100 ppb, such as in an amount greater than about 200 ppb, such as in an amount greater than about 500 ppb, such as in an amount greater than about 700 ppb, such as in an mount greater than about 1,000 ppb, such as in an amount greater than about 10,000 ppb.

As described above, the particle capturing treatment contains a particle resistant agent. In one aspect, the particle resistant agent comprises a polymer. The polymer can be anionic, cationic, or nonionic depending upon various factors including the type of yarns used to construct the fabric. In one aspect, the particle resistant agent comprises a polyurethane polymer. The polyurethane polymer can be water-based and can be applied to the fabric in an aqueous dispersion. The polyurethane polymer, for instance, can be an anionic polyurethane polymer. The polyurethane polymer can also be an aliphatic polyurethane polymer. Alternatively, the polyurethane polymer can have a branched structure. In one aspect, the particle resistant agent comprises a an ether polyurethane polymer combined with an aliphatic polyester.

Alternatively, the particle resistant agent can comprise an acrylic polymer, such as an acrylate or a polyacrylate. In one embodiment, the particle resistant agent comprises an acrylic copolymer. The acrylic polymer, for instance, may have CAS No. 1811502-39-2. In one aspect, the acrylic polymer can be self-crosslinking and form a crosslinked acrylic polymer when applied to the fabric and dried.

In still another embodiment, the particle resistant agent can comprise a silicone polymer. The silicone polymer, for instance, can be water dispersible or can be dispersible in other solvents.

In another aspect, the particle resistant agent can comprise a wax or lower molecular weight polymer. The wax, for instance, can be a polyolefin polymer, a paraffin wax, or mixtures thereof. The polyethylene polymer, for instance, can be a low density polyethylene polymer, a linear low density polyethylene polymer, a low molecular weight polyethylene polymer, or mixtures thereof. In one aspect, the particle resistant agent can comprise a blend of a paraffin wax and a melamine component. Alternatively, the formulation can be melamine-free.

In one aspect, the particle capturing treatment can include a combination of two or more particle resistant agents. For instance, the particle capturing treatment can contain a polyurethane polymer in combination with an acrylic polymer, can contain a polyurethane polymer in combination with one or more polyethylene polymers, can contain a polyurethane polymer in combination with a silicone polymer, can contain an acrylic polymer in combination with a silicone polymer and all of the above combinations can further contain a wax. In another aspect, the particle resistant agent can include a first polyurethane polymer combined with a second polyurethane polymer. Alternatively, the particle resistant treatment can comprise a first acrylic polymer combined with a second acrylic polymer. For instance, one of the acrylic polymers can comprise a polyacrylate. A blend of polyurethanes can be combined with a wax and/or a blend of acrylic polymers can also be combined with a wax. Alternatively, the particle capturing treatment can be formulated to have a single particle resistant agent, such as a wax.

In one aspect, the particle capturing treatment comprises a particle resistant agent that is derived from sustainable resources, such as biomass. The particle resistant agent, for instance, can have a mean bio-based carbon content of at least about 25%, such as at least about 30%, such as at least about 35%, such as at least about 40%, such as at least about 45%, such as at least about 50%, such as at least about 55%, such as at least about 60%, such as at least about 65%, such as at least about 70%. The particle resistant agent, for instance, can have a bio-based carbon content of up to 100%.

Bio-based particle resistant agents that can be incorporated into the particle capturing treatment composition of the present disclosure include, in one embodiment, an acrylate or a urethane.

The bio-based acrylate can be, for instance, an alkyl acrylate. The alkyl group, for instance, can have a carbon chain length of from about 1 carbon atom to about 32 carbon atoms including all species therebetween. In one aspect, the alkyl group can be a linear group. Alternatively, the alkyl group can be branched. In one embodiment, the alkyl group on the alkyl acrylate has a relatively small carbon chain length, such as from about C1 to about C8. For instance, the carbon chain length can be less than about 7 carbon atoms, such as less than about 6 carbon atoms, such as less than about 5 carbon atoms, such as less than about 4 carbon atoms. Alternatively, the alkyl group on the acrylate can have a carbon chain length of greater than about 8 carbon atoms, such as greater than about 10 carbon atoms, such as greater than about 12 carbon atoms, such as greater than about 14 carbon atoms, and generally less than about 28 carbon atoms, such as less than about 24 carbon atoms, such as less than about 20 carbon atoms, such as less than about 14 carbon atoms. The alkyl acrylate particle resistant agent, in one embodiment, can have a mean bio-based content of greater than about 20%, such as greater than about 30%, such as greater than about 40%, and less than about 100%, such as less than about 80%, such as less than about 60%, such as less than about 50%.

In addition to an alkyl acrylate particle resistant agent, another bio-based particle resistant agent can comprise a urethane, such as a polyurethane.

Each particle resistant agent or the total amount of particle resistant agents can be present in the dried particle capturing treatment (without water or solvents) in an amount greater than about 10% by weight, such as in an amount greater than about 20% by weight, such as in an amount greater than about 40% by weight, such as in an amount greater than about 50% by weight, such as in an amount greater than about 60% by weight, and in an amount less than about 98% by weight, such as in an amount less than about 95% by weight, such as in an amount less than about 90% by weight, such as in an amount less than about 88% by weight.

In one embodiment, the particle capturing treatment can also contain a crosslinking agent, such as a latent crosslinking agent. The crosslinking agent, for instance, can comprise an isocyanate, such as a blocked isocyanate. In one aspect, the blocked isocyanate can be an oxime-blocked isocyanate. In one aspect, the blocked isocyanate can be applied to the fabric and then activated to crosslink one or more polymers within the particle capturing treatment after the fabric is dried and heated. The crosslinking agent can be present in the dried coating in an amount greater than about 0.01% by weight, such as in an amount greater than about 0.08% by weight, such as in an amount greater than about 0.1% by weight, such as in an amount greater than about 0.12% by weight, and in an amount less than about 5% by weight, such as in an amount less than about 2% by weight, such as in an amount less than about 1% by weight, such as in an amount less than about 0.5% by weight, such as in an amount less than about 0.3% by weight.

The particle capturing treatment can also optionally contain an optical brightener. The optical brightener, for instance, can comprise a fluorescent agent for increasing whiteness and brightness without compromising the low lint producing properties of the fabric. Optical brighteners that can be used include stilbene derivatives, such as stilbene 4,4′-bis(2-morpholino-4-anilino-s-triazine), coumarin derivatives, such as 7-diethylamino-4-methylcoumarin or 1,2-bis(5-methyl-2-benzoxazolyl) ethene, or a triazine derivative, such as 2,2′-(1,2-ethenediyl)bis [5-(tert-butyl)-1,3-benzoxazole] or 1,4-bis(benzoxazol-2-yl) naphthalene. One or more optical brighteners can be present in the dried coating in an amount greater than about 0.001% by weight, such as in an amount greater than about 0.01% by weight, such as in an amount greater than about 0.1% by weight, such as in an amount greater than about 0.12% by weight, and in an amount less than about 3% by weight, such as in an amount less than about 1% by weight, such as in an amount less than about 0.5% by weight, such as in an amount less than about 0.3% by weight.

The particle capturing treatment can also contain one or more wetting agents and a pH adjusting agent. The pH adjusting agent, for instance, can comprise acetic acid.

In one embodiment, the fabric can also be treated with an antimicrobial agent. The antimicrobial agent can be contained in the particle capturing treatment or can be added to the fabric separately. In one aspect, efficiencies are gained by adding the antimicrobial agent directly to the particle capturing treatment. It was unexpectedly discovered that the presence of an antimicrobial agent actually can further serve to decrease the lint properties of the fabric.

In one aspect, the antimicrobial agent can comprise a quaternary ammonium compound. The quaternary ammonium compound, for instance, can comprise benzalkonium halide such as benzalkonium chloride, a dodecyl benzene sulfonic acid ammonium salt, an alkyldimethyl ammonium halide such as an alkyldimethyl ammonium chloride, an alkyldimethyl benzyl ammonium chloride, a dodecyl trimethyl ammonium halide such as dodecyl trimethyl ammonium bromide, a polyquaternium compound, a silane quaternary ammonium compound, or mixtures thereof.

In one embodiment, the antimicrobial agent comprises a silane quaternary ammonium compound alone or in combination with another quaternary ammonium compound. The silane quaternary ammonium compound, for instance, can be a silane quaternary ammonium halide. In one aspect, the silane quaternary ammonium compound comprises 3-(trimethoxysilyl) ammonium halide compound, such as 3-(trimethoxylsilyl) propyldimethyloctadecyl ammonium chloride.

One or more antimicrobial agents can be added to the fabric in an amount greater than about 0.001% by weight, such as in an amount greater than about 0.01% by weight, such as in an amount greater than about 0.05% by weight, such as in an amount greater than about 0.1% by weight, such as in an amount greater than about 0.12% by weight and in an amount less than about 4% by weight, such as in an amount less than about 3% by weight, such as in an amount less than about 2% by weight, such as in an amount less than about 1% by weight, such as in an amount less than about 0.8% by weight, such as in an amount less than about 0.5% by weight, such as in an amount less than about 0.3% by weight.

The particle capturing treatment and/or antimicrobial agent can be applied to the fabric using any suitable method or technique. In one aspect, the fabric material can optionally be scoured using, for instance, an alkaline solution. After being scoured, the fabric material can be put on a tenter frame, dried and heat set.

The particle capturing treatment can be applied to at least one side of the fabric. The particle capturing treatment, for instance, can be sprayed onto the fabric as a liquid or foam. Alternatively, the particle capturing treatment can be printed onto one or both sides of the fabric. In still another embodiment, the fabric can be dipped into a bath containing the particle capturing treatment. After the particle capturing treatment is applied to the fabric, the fabric can be dried and optionally heated to a temperature that causes at least one component in the treatment to cure and/or crosslink.

The amount of the particle capturing treatment applied to the fabric material will depend upon the particular formulation and the particular application. The dry add on can be greater than about 0.5% by weight, such as greater than about 1% by weight, such as greater than about 1.5% by weight, such as greater than about 2% by weight, such as greater than about 2.5% by weight, such as greater than about 3% by weight, and generally less than about 7% by weight, such as less than about 5% by weight, such as less than about 4% by weight, such as less than about 3.5% by weight.

In one embodiment, after the particle capturing treatment has been applied to the fabric, the yarns in the fabric can be flattened. The yarns can be flattened by applying pressure optionally in combination with heat. For instance, in one embodiment, the treated fabric can be calendered. Calendering can further decrease the lint properties of the fabric. During calendering, the fabric can be passed through a pair of pressure rolls wherein at least one of the rolls is heated.

Fabrics and garments made according to the present disclosure display many beneficial properties. As described above, the fabric has very low lint properties and displays extremely low particle emission rates when measuring particles having a particle size of 0.5 microns or greater. Garments made in accordance with the present disclosure, for instance, can exhibit a particle emission rate that qualifies the garments as Category I garments as described in IEST-RP-CC003.5, which is incorporated herein by reference.

For example, the garments of the present disclosure may exhibit a particle emission rate of less than 12,000 particles/minute (particles having a particle size of 0.5 microns or greater), such as less than 10,000 particles/minute, such as less than 5,000 particles/minute, such as less than 1,200 particles/minute, such as less than 1,000 particles/minute, such as less than 500 particles/minute, such as less than 200 particles/minute and generally greater than 0 particles/minute. In general, Category I garments have the lowest particle shed requirements and are considered the cleanest. The fabrics and/or garments of the present disclosure may be classified as a Category I garment. As such, the fabrics and/or garments are designed to produce a minimum of particles.

In addition, the fabric and/or garment of the present disclosure may employ a static dissipate which attracts static charges. For instance, the carbon fibers, such as the bicomponent carbon fibers, may attract and lower the static charges. According to the present disclosure, the fabric may dissipate static electricity that is generated from fabric to fabric and fabric to surface rubbing or contact and minimize the hazards that may be created by static electricity. For instance, the fabric may provide a barrier between static charges generated on personal clothing and static-sensitive components such that the fabric provides electrostatic dissipation across the garment's entire surface reducing the likelihood of damage from an electrostatic discharge.

The static dissipative properties of a fabric and/or garment may be tested by measuring the surface resistance of a fabric to an electrical flow and the static decay of a charge from the fabric.

In general, surface resistance is a measurement of the resistance of an electrical flow over or through a medium such as a fabric and/or garment. Generally, the lower the resistivity, the better a charge is dissipated and the greater the electrostatic discharge protection. The surface resistivity may be measured according to AATCC 76 (NFPA099) using a concentric electrode electrical resistance meter and preconditioning the samples at 50% relative humidity and a temperature of 23° C.±2° C. for approximately 24 hours. Generally, 100 volts are supplied during the tests.

In one embodiment, the fabric and/or garment has a surface resistivity (initially and after 50 laundry cycles) of less than 1×10¹² ohms/square, such as less than 1×10¹¹ ohms/square, such as less than 1×10¹⁰ ohms/square, such as less than 1×10⁹ ohms/square, such as less than 1×10⁸ ohms/square, such as less than about 1×10⁷ ohms/square, such as less than about 5×10⁶ ohms/square and generally greater than about 1×10² ohms/square, such as greater than about 1×10⁴ ohms/square.

The static charge decay test may conform to Federal Test Standard 191A, Method 5931. The test fabric is supported between 2 electrodes then exposed to a 5 kV source. The test conditions are 21° C. and 20% relative humidity. Generally, it may be required that the fabric accepts a minimum of 3 kV and be capable of discharging 10% of this voltage within ½ of a second at the time when the electrodes are grounded.

In one embodiment, the fabric and/or garment may be capable of accepting a voltage of greater than 3 kV even after 25 launderings, such as 50 launderings, such as even 100 launderings. In one embodiment, the fabric and/or garment may be capable of discharging 10% of this voltage in less than % of a second, such as less than 0.25 seconds, such as less than 0.1 seconds, such as less than 0.05 seconds. In one embodiment, the fabric and/or garment may be capable of discharging 10% of the voltage in the above mentioned times even after 25 launderings, such as after 50 launderings, such as after 100 launderings.

The fabrics and/or garments made according to the present disclosure may be lightweight and soft while also providing protection and comfort. The fabrics can be used to produce garments that are breathable. The fabric material can have a water vapor transmission rate (ASTM E96 (D)) of greater than about 1000 g/m2/24 h, such as greater than about 1050 g/m2/24 h and less than about 2000 g/m2/24 h initially and after 50 laundry cycles. The fabric material can have an air porosity (ASTM D737) of greater than about 1 ft3/min/ft2, such as greater than about 1.2 ft3/min/ft2 and less than about 4 ft3/min/ft2.

All different types of protective garments may be made in accordance with the present disclosure. The garments may have a shape and size configured to cover at least a portion of a wearer's body. The protective garments include, for instance, footwear, footwear covers, trousers, jackets, coats, labcoats, frocks, shirts, headwear, hoods, bouffants, gloves, aprons, smocks, masks, face veils, and the like. The fabric can also be used to construct one-piece jumpsuits.

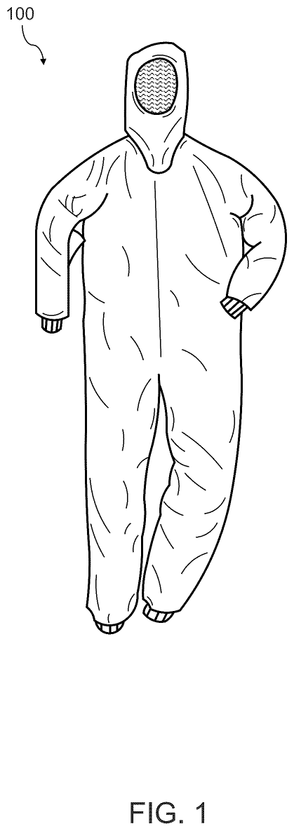

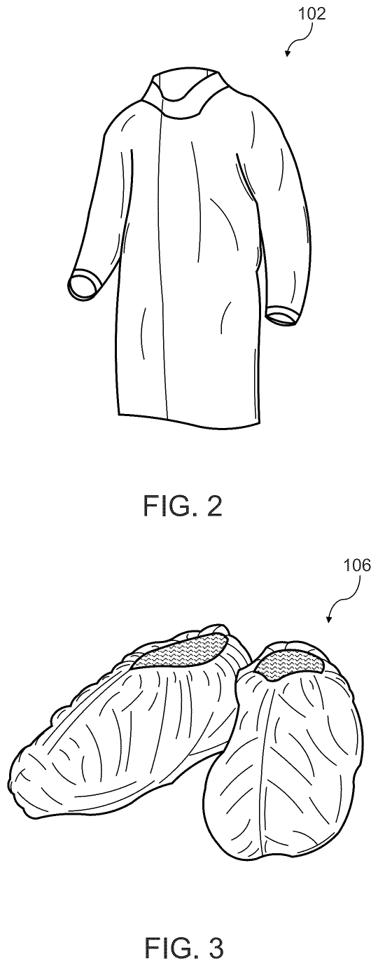

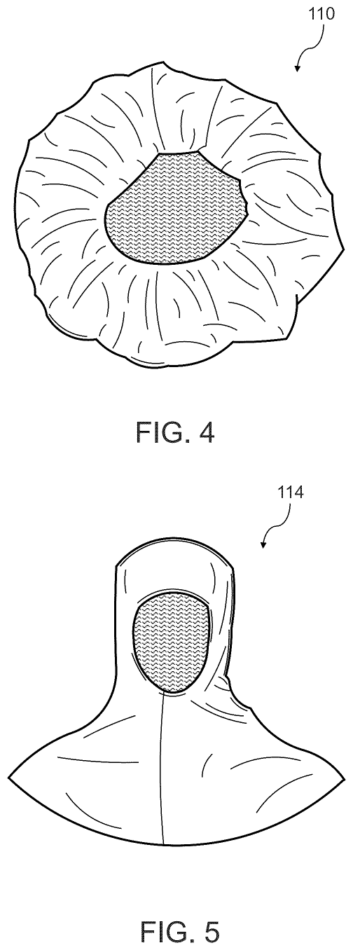

In one embodiment, the fabric may be used to construct a garment worn in a cleanroom. For instance, referring to FIG. 1, one embodiment of a cleanroom garment 100 constructed in accordance with the present disclosure is illustrated. As shown in FIG. 1, the cleanroom garment 100 is a one-piece hooded coverall. However, it should be understood that the clean-room garment may contain multiple pieces. For instance, the coverall may be present without an attached hood. As shown in FIGS. 2 through 5, the clean-room garment may comprise, respectively, a frock/labcoat 102, a shoe cover 106, a bouffant 110, a hood 114, and the like such as pants, boot covers, gloves, aprons, masks, veils, sleeve covers, etc. In addition, these garments may also include undergarments, such as clothes worn under other clothes. In some cases, these undergarments may include those garments worn next to one's body or skin.

The present disclosure may be better understood with reference to the following examples.

### Example No. 1

Various fabrics designed for a cleanroom environment were made in accordance with the present disclosure and tested for particle emission rate and for hydrostatic head.

The fabrics treated were woven fabrics having a plain weave. The fabrics were primarily made from multifilament polyester yarns. The fabrics also contained an anti-static agent comprising bicomponent carbon yarns. The resulting fabric contained polyester in an amount of about 99% by weight and carbon in an amount of about 1% by weight. The polyester yarns had a size of 75 denier. The yarn density in the warp direction was 169 yarns per inch and in the fill direction of 97 yarns per inch. The fabric had a basis weight of 5.29 osy.

Various particle capturing treatments were formulated in accordance with the present disclosure and applied to the fabrics through a dipping process. The treated fabrics were then calendered. The following formulations were used:
Example No. 1:7 to 10% by weight of a polymer wax, 0.3 to 1.5% by weight of a silane quaternary ammonium antimicrobial agent, 1% to 1.5% by weight blocked isocyanate crosslinking agent, 0.1% by weight acetic acid, and 0.1% by weight wetting agent.
Example No. 2:7 to 10% by weight of a polymer wax, 0.3 to 1.5% by weight of an optical brightener, 1% to 1.5% by weight blocked isocyanate crosslinking agent, 0.1% by weight acetic acid, and 0.1% by weight wetting agent.
Example No. 3:8 to 11% by weight of a silicone based water repellent polymer, 1% to 1.5% by weight blocked isocyanate crosslinking agent, 0.1% by weight acetic acid, and 0.1% by weight wetting agent.
Example No. 4:4 to 7% by weight of a polyethylene polymers and 0.1% by weight wetting agent.
Example No. 5: The above treated fabrics were also compared to a commercially available cleanroom fabric that was treated with a C6 fluorocarbon finish.

All three fabrics were subjected to the Helmke Drum Test. As described in the test procedures, each fabric was cut into 3 fabric samples having dimensions of 39.1 inches by 39.1 inches. All 3 samples were tested together such that the total surface area (front and back) being tested was 5.99 m2. During the test, particles were counted having a size of 0.5 microns or greater. The test was conducted after subjecting the fabric samples to 3 laundry cycles, 25 laundry cycles, 50 laundry cycles, 75 laundry cycles, and 100 laundry cycles. The following results were obtained:

| | 3 | 25-29 | 50 | 75 | 100 |
|---|---|---|---|---|---|
| | cycles | cycles | cycles | cycles | cycles |
| Sample | No. of | No. of | No. of | No. of | No. of |
| No. | Particles | Particles | Particles | Particles | Particles |
| 1 | 25 | 66 | 16 | 41 | 117 |
| 2 | 190 | 132 | 69 | 210 | 435 |
| 3 | 806 | 45 | 53 | 131 | 59 |
| 4 | 339 | 18 | 144 | 272 | 117 |
| 5 | 537 | 301 | 39 | 165 | 407 |

As shown, fabrics made according to the present disclosure outperformed the fabric treated with fluoropolymer chemistry in a dramatic fashion. In addition, adding an antimicrobial agent to the particle capturing treatment appears to have improved lint resistance.
Example No. 1 above was also subjected to a hydrostatic head test according to AATC 127-1998. The hydrostatic head test was taken of the original fabric, after 10 laundry cycles, after 25 laundry cycles, after 50 laundry cycles, and after 75 laundry cycles. The following results were obtained:

| | Hydrostatic Head (mm) | | | | |
|---|---|---|---|---|---|
| Sample No. | Original | 10X | 25X | 50X | 75X |
| Sample No. 1 | 1,021 | 963 | 1,037 | 1,067 | 1,001 |

### Example No. 2

Another fabric designed for a cleanroom environment was made in accordance with the present disclosure and tested for particle emission rate. The fabric treated had the same construction as described in Example No. 1.

A particle capturing treatment was formulated in accordance with the present disclosure and applied to the fabrics through a dipping process. The treated fabric was then calendered. The following formulation was used:
Example No. 6:4 to 7% by weight of a polyethylene polymers, 2 to 4% by weight of a bio-based polyurethane (63% by weight renewable content), and 0.1% by weight wetting agent.

The fabric was subjected to the Helmke Drum Test as described above. During the test, particles were counted having a size of 0.5 microns or greater. The following results were obtained:

| | 3 | 10 | 25 | 50 | 75 |
|---|---|---|---|---|---|
| | cycles | cycles | cycles | cycles | cycles |
| Sample | No. of | No. of | No. of | No. of | No. of |
| No. | Particles | Particles | Particles | Particles | Particles |
| 6 | 437.8 | 167.2 | 97.6 | 63.8 | 55.1 |

As shown, the treated fabric displayed excellent lint resistance.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A cleanroom garment comprising:
a fabric material comprising a woven fabric, the fabric comprising filament yarns comprising a polymer, the woven fabric further comprising an anti-static agent;
a particle capturing treatment applied to the fabric material, the particle capturing treatment comprising a particle resistant agent, the particle resistant agent comprising a non-fluorinated polymer; and
wherein the treated fabric material has been flattened, and wherein the garment comprises a head covering, a frock, coveralls, or a foot covering, and wherein the treated fabric material displays a particle emission rate of less than 500 particles having an average particle size of 0.5 microns or greater after 25 laundry cycles when tested according to the Helmke Drum Test.

2. A cleanroom garment as defined in claim 1, wherein the treated fabric material displays a particle emission rate of less than about 500 particles having an average particle size of 0.5 microns or greater after 100 laundry cycles and displays a particle emission rate of less than about 300 particles having an average particle size of 0.5 microns or greater after 25 laundry cycles.

3. A cleanroom garment as defined in claim 1, wherein the treated fabric material displays a hydrostatic head according to Test AATCC-127-2018 of greater than about 700 mm water after 25 laundry cycles.

4. A cleanroom garment as defined in claim 1, wherein the treated fabric material displays a hydrostatic head according to Test AATCC-127-2018 of greater than about 700 mm water after 50 laundry cycles.

5. A cleanroom garment as defined in claim 1, wherein the fabric material is also treated with an antimicrobial agent.

6. A cleanroom garment as defined in claim 5, wherein the antimicrobial agent comprises a quaternary ammonium compound, a silane quaternary ammonium halide, 3-(trimethoxysilyl) propyldimethyloctadecyl ammonium chloride, or mixtures thereof.

7. A cleanroom garment as defined in claim 1, wherein the particle resistant agent comprises a polyurethane polymer.

8. A cleanroom garment as defined in claim 1, wherein the particle resistant agent comprises an acrylic polymer.

9. A cleanroom garment as defined in claim 1, wherein the particle resistant agent comprises a silicone polymer.

10. A cleanroom garment as defined in claim 1, wherein the particle capturing treatment comprises a wax.

11. A cleanroom garment as defined in claim 1, wherein the particle capturing treatment comprises a blocked isocyanate.

12. A cleanroom garment as defined in claim 1, wherein the particle capturing treatment applied to the fabric is fluorine-free.

13. A cleanroom garment as defined in claim 1, wherein the particle capturing treatment comprises a blend of polyethylene polymers.

14. A cleanroom garment as defined in claim 1, wherein the particle capturing treatment comprises a polyurethane polymer in combination with at least one polyethylene polymer.

15. A cleanroom garment as defined in claim 1, wherein the particle resistant agent has a mean bio-based carbon content of at least about 30%.

16. A cleanroom garment as defined in claim 1, wherein the fabric material has a basis weight of from about 2 osy to about 8 osy and wherein the woven fabric comprises multifilament yarns, the fabric having a yarn density in a warp direction of from about 125 yarns per inch to about 200 yarns per inch and in a fill direction of from about 70 yarns per inch to about 120 yarns per inch.

17. A cleanroom garment as defined in claim 1, wherein the anti-static agent comprises conductive fibers, the conductive fibers comprising carbon fibers and wherein carbon is present in the fabric material in an amount from about 0.5% by weight to about 5% by weight.

18. A cleanroom garment as defined in claim 1, wherein the treated fabric material has been flattened by being calendered.

19. A cleanroom garment as defined in claim 1, wherein the filament yarns comprise polyester filament yarns and wherein the woven fabric is pretreated to remove cyclic and linear oligomers from the polyester polymer.

20. A cleanroom garment as defined in claim 1, wherein the filament yarns are made from an inherently flame resistant polymer, the inherently flame resistant polymer comprising a para-aramid polymer, a meta-aramid polymer, or combinations thereof.

21. A cleanroom garment as defined in claim 1, wherein the fabric material further comprises a membrane laminated to the woven fabric.

22. A cleanroom garment as defined in claim 1, wherein the treated fabric material displays a static decay of less than about 2 seconds when measured according to Test FTM4046, displays a surface resistivity of from about 1×10⁵ ohms/square to about 1×10¹² ohms/square when measured according to Test AATCC-76, and displays a particle emission rate of less than about 12,000 particles per minute, such as less than about 10,000 particles per minute, such as less than about 8,000 particles per minute, the measuring particles having a size of 0.5 microns and greater according to Test IEST RP CC003.5.
